(19) United States
(12) Patent Application Publication
(10) Pub. No.: US 2023/0373699 A1
(43) Pub. Date: Nov. 23, 2023

(54) PROTECTIVE PACKAGING SYSTEM

(71) Applicant: 14th Round Inc., Los Angeles, CA (US)

(72) Inventors: Thomas Fornarelli, Los Angeles, CA (US); Jeremy GREEN, Pacific Palisades, CA (US)

(21) Appl. No.: 17/751,408

(22) Filed: May 23, 2022

(51) Int. Cl. B65D 77/04; B65D 75/52; B65D 65/46; B65D 75/26; B65D 75/58; B65D 65/42

(52) U.S. Cl. CPC B65D 77/0406; B65D 75/522; B65D 65/466; B65D 75/26; B65D 75/5805; B65D 65/42; B65D 2575/586

(57) ABSTRACT

A protective packaging system comprises a pouch, and a receptacle for insertion into the pouch. The receptacle comprises a base surface and a perimeter structure extending from the base surface around at least half of the perimeter of the base surface.

### FIELD OF THE INVENTION

The present invention relates generally to a protective packaging system. In particular, the present invention relates to a protective packaging system including a pouch and a crush resistant insert that aids in protecting crushable materials, including for example without limitation, cannabis flower, wherein the packaging system is biodegradable without the need for special recycling treatment.

### BACKGROUND

The cannabis retail industry although relatively new, has an enormous impact on the environment through the packaging used for cannabis products. Such packaging that often relies heavily on the use of plastics and chemicals can not only take thousands of years to degrade in landfills, but harmful toxins from the packaging can also leech into the soil and waterways, potentially impacting areas and environments far away from localized disposal sites. Packaging is still one of the largest contributors to environmental pollution and impact on flora and fauna that we are faced with worldwide today. Encouraging the adoption of biodegradable packaging requires not only a consideration of materials used, but also a recognition of how such materials can actually improve the utility and function of the packaging.

Current cannabis packaging typically utilizes a simple pouch container with or without a child resistant closure. This type of simple pouch is familiar, easily produced, and provides easy access to product for the user. Pouch style packaging efficiently stores multiple product types and generally protects and isolates them in a fresh sealed environment from their surroundings. Pouch style packaging in its popular form allows the user to hold the packaging in one hand while accessing the interior product with the other hand. Filling the pouches with product can be automated or executed by hand. Unfortunately, certain products such as, for example, cannabis flower, that are placed into pouches are non-uniform in size and are inherently fragile in nature. The inherent flexibility of pouches can lead to contents being crushed, which makes them less than optimum for the safe storage and transport of certain cannabis products. Cannabis flower can not only be crushed but can also slide around within the pouch thereby moving to an area of the pouch that is more difficult to access, and thereby providing a less premium experience for the user.

Because fragile plant material stored in a flexible pouch can often be detrimentally crushed during fulfillment, transit, and at retail, there is a need for a protective packaging system for such plant material. It would be beneficial of the protective packaging system had less impact on the environment while providing consumers with enhanced functionality, reusability, flexibility, aesthetics, and design features. It would also be beneficial if the protective packaging system was scalable, having a protective pouch and a crush resistant insert that aided in protecting the delicate plant materials. It would be further beneficial if the crush resistant insert positively engaged the protective cover pouch thereby tensioning the protective cover pouch while also allowing for instant removal and replacement without the need for mechanical manipulation. It would be still further beneficial if the packaging system was biodegradable without the need for special recycling treatment.

### SUMMARY OF THE INVENTION

In one aspect of the invention, a protective packaging system comprises a pouch, and a receptacle for insertion into the pouch. The receptacle comprises a base surface and a perimeter structure extending from the base surface around at least half of the perimeter of the base surface.

In another aspect of the invention, a protective packaging system comprises a receptacle comprising a base surface and a perimeter structure extending from the base surface around at least half of the perimeter of the base surface.

Additional aspects and advantages of the present disclosure will become readily apparent to those skilled in this art from the following detailed description, wherein only illustrative embodiments of the present disclosure are shown and described.

### BRIEF DESCRIPTION OF THE DRAWINGS

FIG. 1 illustrates an exemplary protective packaging system according to an embodiment, including an exemplary pouch shown side by side with an exemplary receptacle, the receptacle including plant material disposed therein;

FIG. 2 illustrates the receptacle including the plant material as shown in FIG. 1 disposed within the pouch as shown in FIG. 1;

FIG. 3 illustrates a perspective view of an exemplary receptacle according to an embodiment;

FIG. 4 illustrates a first side view of the exemplary receptacle of FIG. 3 taken generally along the arrow labeled A in FIG. 3;

FIG. 5 illustrates top plan view of the exemplary receptacle shown in FIG. 3; and

FIG. 6 illustrates a second side view of the exemplary receptacle of FIG. 3 taken generally along the arrow labeled B in FIG. 3.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention. In the descriptions that follow identical reference numerals used to describe components of different disclosed embodiments refer to identical components that may be part of the different disclosed embodiments.

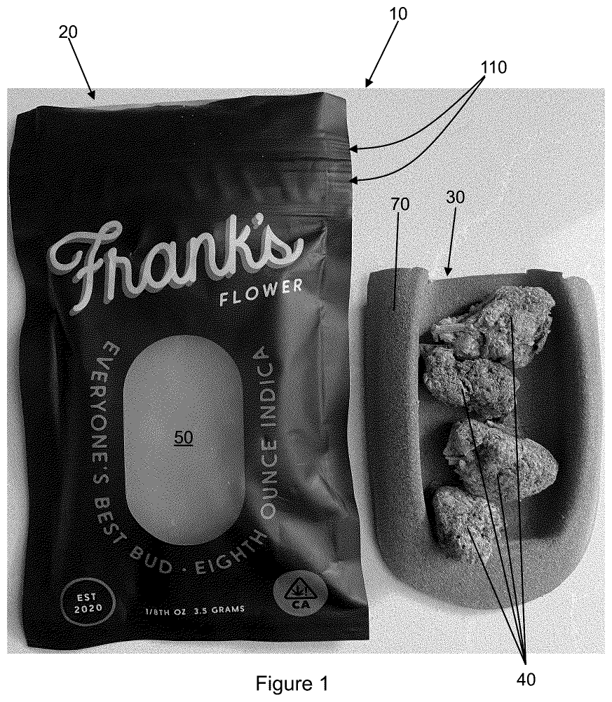

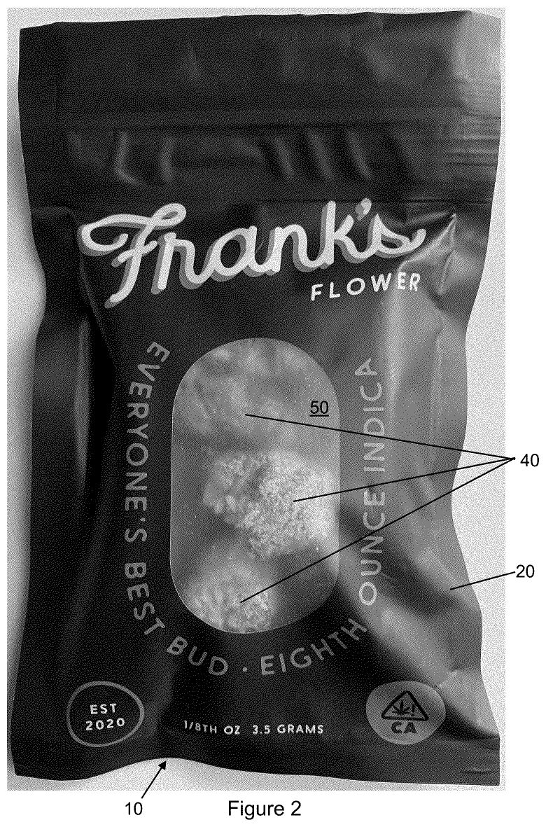

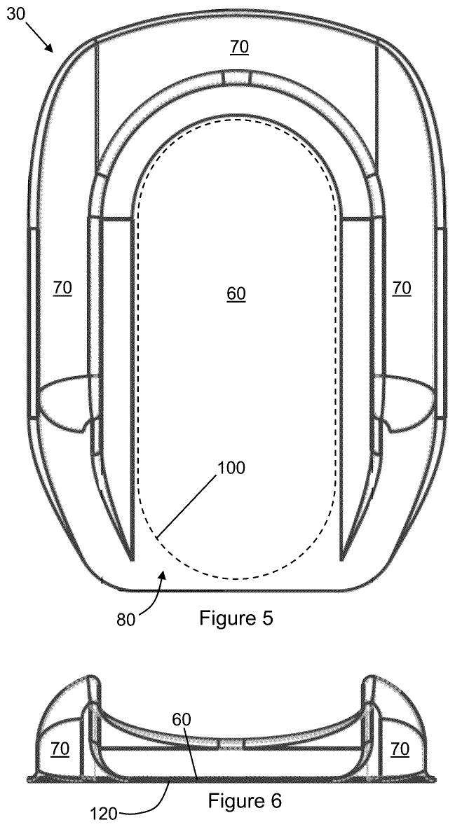

Referring to FIG. 1, an embodiment of a protective packaging system 10 comprising a pouch 20 and a receptacle 30 for insertion into the pouch 20 is shown in a dis-assembled state. Plant material 40, for example without limitation, cannabis flower, is shown disposed within the receptacle 30. As shown in FIG. 2 and as will be described more fully hereinbelow, in an assembled state the protective packaging system 10 protects the plant material 40 from being crushed. In an embodiment the pouch 20 includes a transparent window 50 that is configured to align with a payload region 100 (wherein plant material is disposed as described hereinbelow—also see FIG. 5) when the receptacle 30 is inserted into the pouch 20.

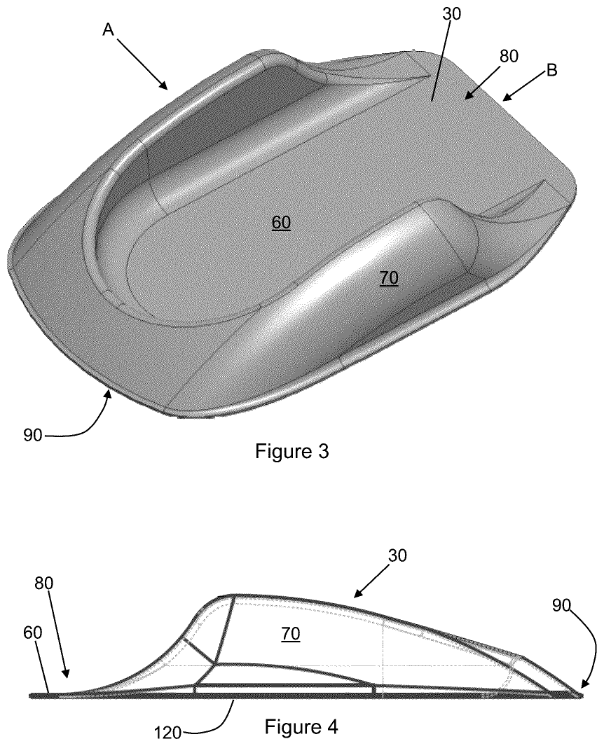

Referring to FIGS. 3-6, the receptacle 30 in an embodiment comprises a base surface 60 and a perimeter structure 70 extending from the base surface 60 around at least half of the perimeter of the base surface 60. In an embodiment, at least a portion 80 of the perimeter of the base surface 60 lacks the perimeter structure 70. For example, without limitation, FIGS. 3 and 5 illustrate the perimeter structure 70 extending from the base surface 60 around about three-quarters of the perimeter of the base surface 60, so that in this exemplary embodiment about one-quarter of the perimeter of the base surface 60 lacks the perimeter structure 70. In other embodiments, the perimeter structure 70 is present around a different fraction that is more than at least half of the perimeter of the base surface 60. In an embodiment the base surface 60 is planar; however, in other embodiments the base surface 60 can be concave or convex.

Referring to FIG. 5, a payload region 100 is generally illustrated by the dashed line 100 and is defined as the volume bounded by the base surface 60 and the perimeter structure 70. Plant material 40 that is placed into the receptacle 30 as illustrated in FIG. 1 is retained within the payload region 100 when the receptacle 30 is placed into the pouch 20. Therefore, the payload region 100 of the receptacle 30 keeps plant material 40 contained within a prescribed volume within the pouch 20.

In an embodiment the receptacle 30 is designed to conform to the pouch 20 when inserted therein without distorting the customer facing view through the window 50 with creases and wrinkles. In addition, in an embodiment the perimeter structure 70 is contoured and profiled to match the transparent window 50 of the pouch 20 when placed therein so as to present product plant material 40 within the pouch 20 at its optimum viewing angle through the window 50. Further, the perimeter structure 70 is sized relative to the pouch 20 so that insertion of the receptacle 30 into the pouch 20 tensions the surface of the pouch 20. For example, the window 50 visible in FIG. 2 is under tension.

Such tensioning of the surface of the pouch 20 is caused by the perimeter structure 70 being sized to be snugly disposed within and pushing outwardly against the inner surfaces of the pouch 20, to effectively form the pouch 20 into a tensioned tent structure, which results in the surface of the pouch 20 being pulled tightly under tension. The tensioned surface of the pouch 20 in combination with the base surface 60 and the perimeter structure 70 of the receptacle 30 defines a no-crush volume that includes the payload region 100, wherein disposed plant material 40 is protected from being crushed while being transported, displayed, or otherwise handled.

As best visible in FIG. 4, in an embodiment the perimeter structure 70 tapers toward an edge 90 of the receptacle 30 opposite the portion 80 of the perimeter of the base surface 60 that lacks the perimeter structure 70. The taper at the edge 90 provides the receptacle 30 with a lead in angle design that makes the receptacle 30 easier to insert into the pouch 20. In an embodiment, the receptacle 30 is flat on a side 120 opposite the perimeter structure 70. In other embodiments, the receptacle 120 is concave or convex on the side 120. Regardless of whether the side 120 is flat, convex, or concave, the side 120 can be useful for labeling and merchandizing, for example by printing labels or merchandizing information on the side 120 and making a corresponding side of the pouch 20 transparent. The overall structure of the receptacle 30 as described hereinabove is also believed to aid in inserting a receptacle 30 loaded with plant material 40 into the pouch 20 by holding the plant material 40 in place during insertion.

Referring again to FIG. 1, in an embodiment the pouch 20 is resealable, for example without limitation, by including one or more closures 110 across a mouth of the pouch 20. In an embodiment the pouch 20 includes a one-time seal that is broken, for example without limitation, by tearing off an end of the pouch 20 along a line of weakness or a tear line (not shown). Once the pouch 20 has been opened via destruction of the one-time seal, the one or more closures 110 can be engaged to reseal the pouch 20. The one or more closures 110 can be any sort of complementary mating structures that extend inwardly from the walls of the pouch 20 as are known in the art for forming a closure across the pouch opening.

Material and manufacturing processes used to make the protective packaging system 10, including both the pouch 20 and the receptacle 30 as described herein allow for biodegradability and/or recyclability. In an embodiment, biodegradable materials such as, for example without limitation, bio-resins, and paper pulp substrates are utilized to manufacture the pouch 20 and the receptacle 30.

In an embodiment, the receptacle 30 is manufactured from a paper pulp material covered with a thin, for example without limitation, less than 30 micron thick biodegradable bio-based plastic film that can be formed and molded at the same time of fabrication of the receptacle 30. The use of a biodegradable bio-based plastic film or other durable film material has been found helpful in eliminating short term failure of structural integrity of paper pulp due to external climatic and environmental influences. Such biodegradable bio-based plastic film or other durable film material also helps to maintain the structural integrity of the receptacle 30 by mitigating the absorption of botanical or edible products into the paper pulp material.

Moisture, humidity, and heat affects paper and organic based products quicker than their plastic counterparts. Laminations of films has long been seen as a solution to paper failures, but fossil-based plastics (98% of all plastics worldwide) do not biodegrade quickly (taking hundreds of years) and cannot be recycled through a single stream recycling facility. By utilizing biodegradable bio-based films the pouch 20 and the receptacle 30 can both be biodegradable without affecting single stream recycling of paper and pulp products.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INDUSTRIAL APPLICABILITY

A protective packaging system for preventing the crushing of crushable materials includes a pouch and a receptacle for insertion into the pouch. The receptacle has a structure that forms the pouch into a tensioned tent when placed therein, which results in the formation of a crush-free volume within the pouch. The protective packaging system can be manufactured in industry for use by packagers of crushable materials and by consumers of the crushable materials.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A protective packaging system, comprising:
a pouch;
a receptacle for insertion into the pouch, the receptacle comprising a base surface and a perimeter structure extending from the base surface around at least half of a perimeter of the base surface, wherein the perimeter structure is sized relative to the pouch so that insertion of the receptacle into the pouch tensions the surface of the pouch.

2. (canceled)

3. The protective packaging system of claim 1, wherein at least a portion of the perimeter of the base surface lacks the perimeter structure, and the perimeter structure tapers toward an edge of the receptacle opposite the portion.

4. The protective packaging system of claim 1, wherein a payload region is defined by a volume bounded by the base surface and the perimeter structure.

5. The protective packaging system of claim 4, wherein the pouch includes a transparent window that is configured to align with the payload region of the base surface when the receptacle is inserted into the pouch.

6. The protective packaging system of claim 1, wherein the receptacle is flat on a side opposite the perimeter structure.

7. The protective packaging system of claim 1, wherein the receptacle and the pouch are made from biodegradable materials.

8. The protective packaging system of claim 7, wherein the receptacle is coated with a layer of a biodegradable film.

9. The protective packaging system of claim 1, wherein the pouch further comprises one or more closures disposed across a mouth of the pouch, thereby making the pouch resealable.

10. A protective packaging system, comprising:
a receptacle comprising a base surface and a perimeter structure extending from the base surface around a perimeter of the base surface except for a portion of the perimeter of the base surface that lacks the perimeter structure, wherein the perimeter structure tapers toward an edge of the receptacle opposite the portion.

11. (canceled)

12. The protective packaging system of claim 10, wherein the receptacle is flat on a side opposite the perimeter structure.

13. The protective packaging system of claim 10, wherein the receptacle is made from a biodegradable material.

14. The protective packaging system of claim 13, wherein the receptacle is coated with a layer of a biodegradable film.

15. The protective packaging system of claim 10, further comprising a pouch.

16. The protective packaging system of claim 15, wherein the perimeter structure is sized relative to the pouch so that insertion of the receptacle into the pouch tensions the surface of the pouch.

17. The protective packaging system of claim 15, wherein the pouch is made from a biodegradable material.

18. The protective packaging system of claim 15, wherein the pouch comprises one or more closures disposed across a mouth of the pouch, thereby making the pouch resealable.

19. The protective packaging system of claim 15, wherein a payload region is defined by a volume bounded by the base surface and the perimeter structure.

20. The protective packaging system of claim 19, wherein the pouch includes a transparent window that is configured to align with the payload region of the base surface when the receptacle is inserted into the pouch.
